(19) United States
(12) Patent Application Publication
(10) Pub. No.: US 2024/0292405 A1
(43) Pub. Date: Aug. 29, 2024

(54) Intra-User Equipment-Coordination Set Communication

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 18/571,595

(22) PCT Filed: Jun. 24, 2022
(86) PCT No.: PCT/US2022/073143

§ 371 Date: Dec. 18, 2023

Related U.S. Application Data
(60) Provisional application No. 63/217,043, filed on Jun. 30, 2021.

(51) Int. Cl. H04W 72/121; H04W 76/10; H04W 76/20; H04W 92/10

(52) U.S. Cl. CPC H04W 72/121; H04W 76/10; H04W 76/20; H04W 92/10

(57) ABSTRACT

Methods, devices, systems, and means for intra-UECS communication by a coordinating user equipment, UE, in a user equipment-coordination set, UECS, are described herein. The coordinating UE allocates first air interface resources to a second UE and second air interface resources to a third UE for intra-UECS communication. The coordinating UE receives, using the allocated first air interface resources, an Internet Protocol, IP, data packet from the second UE in the UECS. The coordinating UE determines that a destination address included in the IP data packet is an address of the third UE and transmits, using the allocated second air interface resources, the IP data packet to the third UE.

### BACKGROUND

Generally, a provider of a wireless network manages wireless communications over the wireless network. For example, a base station manages a wireless connection with a user equipment (UE) that is connected to the wireless network. The base station routes data communications between UEs and between a UE and external networks.

The quality of service between the UE and a base station can be degraded by a number of factors, such as loss in signal strength, bandwidth limitations, interfering signals, and so forth. This is particularly true for UEs operating at a cell edge that are frequently troubled by weak signal quality. While the use of a User Equipment-Coordination Set (UECS) can remedy some of these degradations, techniques for intra-UECS communication can provide reliable, low-latency communications between UEs in a UECS.

### SUMMARY

This summary is provided to introduce simplified concepts of intra-user equipment-coordination set communication. The simplified concepts are further described below in the Detailed Description. This summary is not intended to identify essential features of the claimed subject matter nor is it intended for use in determining the scope of the claimed subject matter.

In aspects, methods, devices, systems, and means for intra-UECS communication describes a coordinating equipment (UE) allocating first air interface resources to a second UE and second air interface resource to a third UE for intra-UECS communication. Using the allocated first air interface resources, the coordinating UE receives an Internet Protocol (IP) data packet from the second UE in the UECS. The coordinating UE determines that a destination address included in the IP data packet is an address of the third UE and, using the allocated second air interface resources, transmits the IP data packet to the third UE.

### BRIEF DESCRIPTION OF THE DRAWINGS

The details of one or more aspects of intra-user equipment-coordination set communication are described below. The use of the same reference numbers in different instances in the description and the figures indicate similar elements:

FIG. 1 illustrates an example operating environment in which aspects of intra-user equipment coordination set communication can be implemented.

FIG. 2 illustrates an example device diagram of a user equipment and a serving cell base station.

FIG. 3 illustrates an example block diagram of a wireless network stack model in which various aspects of intra-user equipment-coordination set communication can be implemented.

FIG. 4 illustrates an example environment in which various aspects of intra-user equipment-coordination set communication can be implemented.

FIG. 5 illustrates an example environment in which various aspects of intra-user equipment-coordination set communication can be implemented.

FIG. 6 illustrates an example block diagram of Internet Protocol (IP) routing using layers of the wireless network stack model with which various aspects of intra-user equipment-coordination set communication can be implemented in accordance with aspects of intra-user equipment-coordination set communication.

FIG. 7 illustrates example data and control transactions between devices of a user equipment-coordination set for intra-UECS communication in accordance with aspects of intra-user equipment-coordination set communication.

FIG. 8 illustrates an example method of intra-user equipment-coordination set communication as generally related to related to routing intra-UECS packet data communications between UEs in the UECS in accordance with aspects of the techniques described herein.

### DETAILED DESCRIPTION

A user equipment-coordination set (UECS) can improve the link budget and range between user equipment (UE) and a base station. In certain scenarios, intra-UECS (UE-to-UE) communications can also be valuable to users, such as when there is no infrastructure (e.g., base station) available or to reduce the latency for UE-to-UE communications.

UEs can engage in peer-to-peer communication using technologies in unlicensed frequency bands, such as Wi-Fi Direct. However, these contention-based communications technologies can increase communication latency, have lower reliability, and poorer link budgets than communications using allocated resources in a licensed communication system.

UEs attempting peer-to-peer communication may also encounter challenges due to blocking (e.g., by buildings, terrain, vehicles, and such) in mmWave or THz bands, and/or insufficient link budgets. In addition to using licensed spectrum resources allocated by a coordinating UE in a UECS, intra-UECS communications may include routed or relayed communications in which communications between two UEs are routed or relayed by a third UE (e.g., the coordinating UE) in the UECS. Routing or relating intra-UECS communications provides communications between UEs when the UEs are out of range of a Radio Access Network (RAN) or experience blockages to peer-to-peer communication.

A UECS is formed by multiple UEs assigned as a group to function together, similarly to a distributed antenna, for the benefit of a particular UE (e.g., target UE). The UECS includes a coordinating UE that coordinates joint transmission and reception of downlink and/or uplink signals for the target UE or multiple target UEs in the UECS. By combining antennas and transmitters of multiple UEs in the UECS, the effective transmit power of the target UE is significantly increased, and the effective signal quality is greatly improved.

Multiple UEs can each receive downlink data transmissions from the base station. Unlike conventional relay techniques, these UEs do not decode the downlink transmissions into data packets and then forward the data packets to a destination. Rather, the UEs demodulate and sample the downlink transmissions to produce I/Q samples. The UEs determine where to forward the I/Q samples of the downlink transmissions, such as to a coordinating UE for decoding. Note that a single UE may simultaneously have the roles of a coordinating UE and a target UE. The target UE may be included in a subset of target UEs within the UECS. The coordinating UE receives the I/Q samples from the other UEs in the UECS and stores the I/Q samples in a buffer memory for decoding. However, if the target UE is the coordinating UE, then the target UE does not wirelessly forward the I/Q samples to itself. Then, the coordinating UE synchronizes and decodes the stored I/Q samples into data packets for transmission to the target UE(s). Accordingly, the processing of the I/Q samples occurs at the coordinating UE. In this way, the UECS acts as a distributed antenna for the target UE.

Several UEs may be able to monitor a base station but individually each UE is unable to reliably communicate with the base station. In this circumstance, the several UEs can form a UECS to communicate with the base station without the base station determining the configuration of the UECS and/or selecting a coordinating UE for the UECS. In the absence of a configuration from the base station, the UEs in the UECS require a technique for selecting a coordinating UE for the UECS, especially in the event that none of the UEs indicates a preference to be the coordinating UE.

### Example Environments

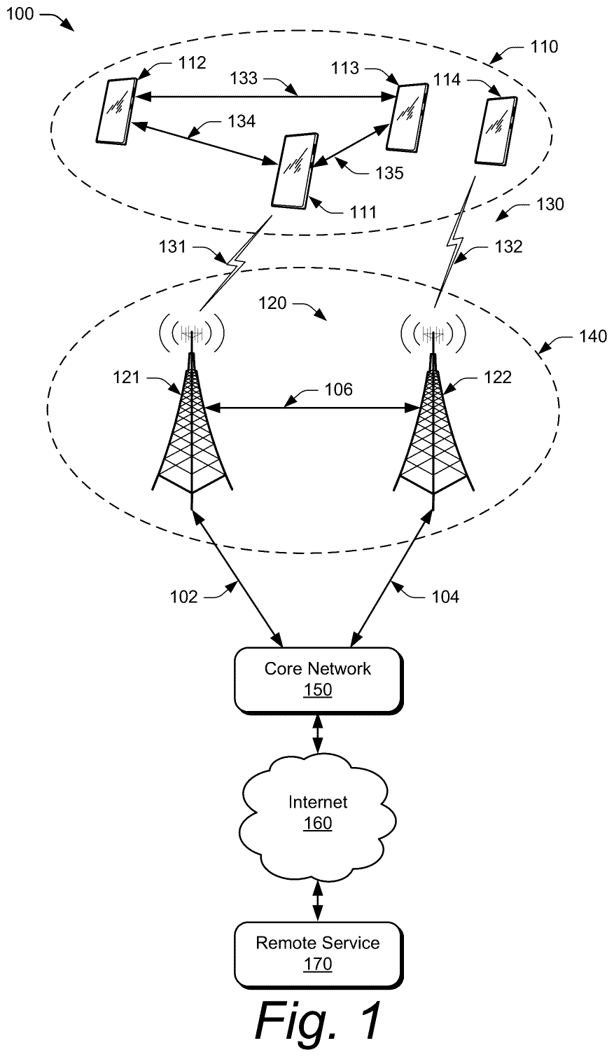

FIG. 1 illustrates an example environment 100, which includes multiple user equipment 110 (UE 110), illustrated as UE 111, UE 112, UE 113, and UE 114. When in communication range of a base station, each UE 110 can communicate with one or more base stations 120 (illustrated as base stations 121 and 122) through one or more wireless communication links 130 (wireless link 130), illustrated as wireless links 131 and 132. When individual UEs, such as the UE 111, the UE 112, and the UE 113 are individually out of communication range of a base station, those UEs can form a UECS and use joint-transmission and joint-reception to communicate with a base station. Each UE 110 in a UECS (illustrated as UE 111, UE 112, and UE 113) can communicate with a coordinating UE of the UECS and/or a target UE in the UECS through one or more local wireless network connections (e.g., WLAN, Bluetooth, NFC, a personal area network (PAN), WiFi-Direct, IEEE 802.15.4, ZigBee, Thread, millimeter wavelength communication (mmWave), licensed-band resources of a RAN, or the like) such as local wireless network connections 133, 134, and 135. Although illustrated as a smartphone, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, an Internet-of-things (IoT) device (e.g., sensor node, controller/actuator node, combination thereof), and the like. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station or the like, or any combination or future evolution thereof.

The base stations 120 communicate with a UECS or a user equipment 110 using the wireless links 131 and 132, respectively, which may be implemented as any suitable type of wireless link. The wireless links 131 and 132 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and future evolutions. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an SI interface for control-plane signaling and user-plane data communications when connecting to an Evolved Packet Core (EPC) network. The base stations 121 and 122 can communicate using an Xn Application Protocol (XnAP) through an Xn interface or using an X2 Application Protocol (X2AP) through an X2 interface, at 106, to exchange user-plane and control-plane data. The user equipment 110 may connect, via the core network 150, to public networks, such as the Internet 160 to interact with a remote service 170.

### Example Devices

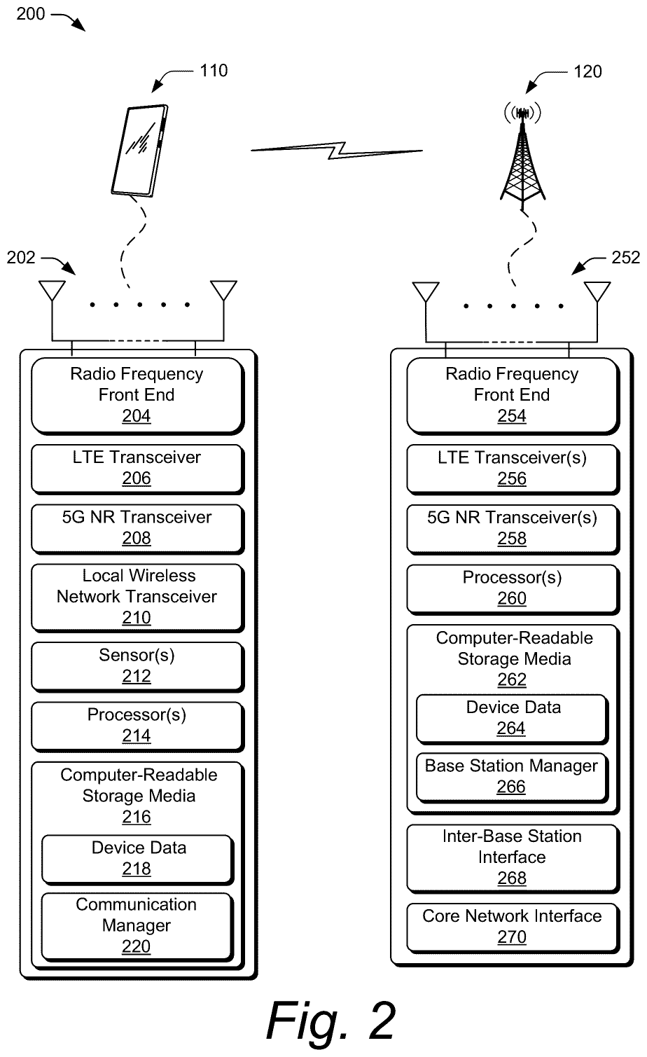

FIG. 2 illustrates an example device diagram 200 of a user equipment and a base station. In aspects, the device diagram 200 describes devices that can implement various aspects of intra-user equipment-coordination set communication. Included in FIG. 2 are the multiple UE 110 and the base stations 120. The multiple UE 110 and the base stations 120 may include additional functions and interfaces that are omitted from FIG. 2 for the sake of clarity. The UE 110 includes antennas 202, a radio frequency front end 204 (RF front end 204), and radio-frequency transceivers (e.g., an LTE transceiver 206 and a 5G NR transceiver 208) for communicating with base stations 120 in the 5G RAN 141 and/or the E-UTRAN 142. The UE 110 includes one or more additional transceivers (e.g., local wireless network transceiver 210) for communicating over one or more wireless local wireless networks (e.g., WLAN, Bluetooth, NFC, a personal area network (PAN), WiFi-Direct, IEEE 802.15.4, ZigBee, Thread, mmWave, licensed-band resources of a RAN, or the like) with at least the coordinating UE of the UECS. The RF front end 204 of the UE 110 can couple or connect the LTE transceiver 206, the 5G NR transceiver 208, and the local wireless network transceiver 210 to the antennas 202 to facilitate various types of wireless communication.

The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards. In addition, the RF front end 204 can be tuned to, and/or be tunable to, one or more frequency bands defined and implemented by the local wireless network transceiver 210 to support transmission and reception of communications with other UEs in the UECS over a local wireless network.

The UE 110 includes sensor(s) 212 can be implemented to detect various properties such as temperature, supplied power, power usage, battery state, or the like. As such, the sensors 212 may include any one or a combination of temperature sensors, thermistors, battery sensors, and power usage sensors.

The UE 110 also includes processor(s) 214 and computer-readable storage media 216 (CRM 216). The processor 214 may be a single core processor or a multiple core processor composed of a variety of materials, such as silicon, polysilicon, high-K dielectric, copper, and so on. The computer-readable storage media described herein excludes propagating signals. CRM 216 may include any suitable memory or storage device such as random-access memory (RAM), static RAM (SRAM), dynamic RAM (DRAM), non-volatile RAM (NVRAM), read-only memory (ROM), or Flash memory useable to store device data 218 of the UE 110. The device data 218 includes user data, multimedia data, beamforming codebooks, applications, and/or an operating system of the UE 110, which are executable by processor(s) 214 to enable user-plane communication, control-plane signaling, and user interaction with the UE 110.

CRM 216 also includes a communication manager 220 (e.g., a communication manager application 220). Alternately or additionally, the communication manager 220 may be implemented in whole or part as hardware logic or circuitry integrated with or separate from other components of the UE 110. In at least some aspects, the communication manager 220 configures the RF front end 204, the LTE transceiver 206, the 5G NR transceiver 208, and/or the local wireless network transceiver 210 to implement the techniques described herein for intra-user equipment-coordination set communication.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with any UE 110 in a UECS.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, beamforming codebooks, applications, and/or an operating system of the base stations 120, which are executable by processor(s) 260 to enable communication with the UE 110.

CRM 262 also includes a base station manager 266 (e.g., base station manager application 266). Alternately or additionally, the base station manager 266 may be implemented in whole or part as hardware logic or circuitry integrated with or separate from other components of the base stations 120. In at least some aspects, the base station manager 266 configures the LTE transceivers 256 and the 5G NR transceivers 258 for communication with the UE 110, as well as communication with a core network. The base stations 120 include an inter-base station interface 268, such as an Xn and/or X2 interface, which the base station manager 266 configures to exchange user-plane and control-plane data between another base station 120, to manage the communication of the base stations 120 with the UE 110. The base stations 120 include a core network interface 270 that the base station manager 266 configures to exchange user-plane and control-plane data with core network functions and entities.

### Network Stack

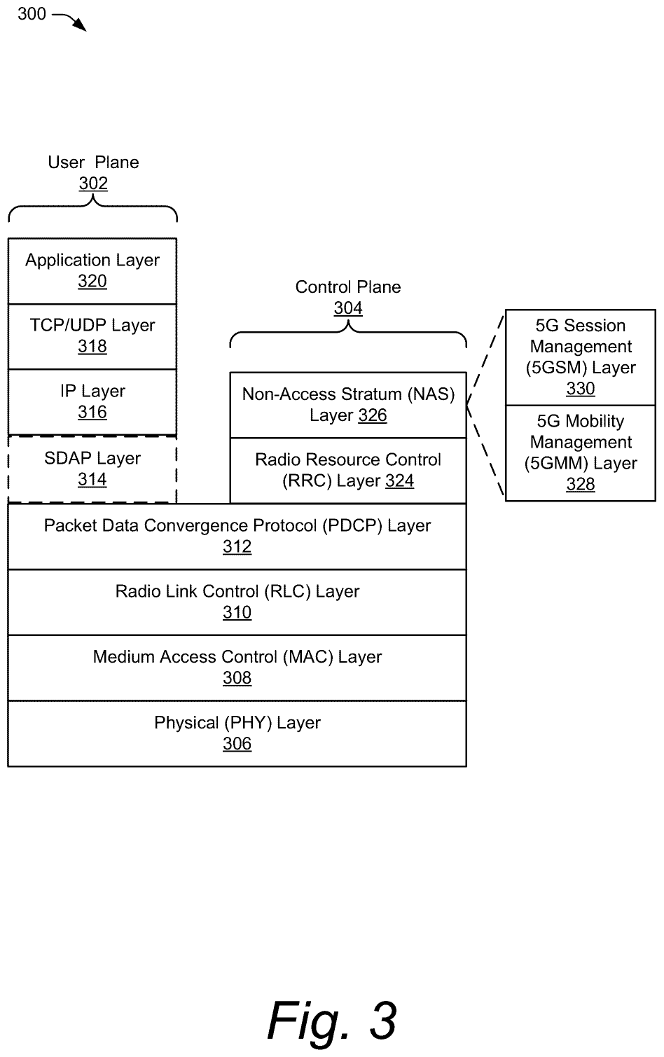

FIG. 3 illustrates an example block diagram 300 of a wireless network stack model 300 (network stack, stack 300). The network stack 300 characterizes a communication system for the example environment 100, in which various aspects of intra-user equipment-coordination set communication can be implemented. The network stack 300 includes a user plane 302 and a control plane 304. Upper layers of the user plane 302 and the control plane 304 share common lower layers in the network stack 300. Wireless devices, such as the UE 110 or the base station 120, implement each layer as an entity for communication with another device using the protocols defined for the layer. For example, a UE 110 uses a Packet Data Convergence Protocol (PDCP) entity to communicate to a peer PDCP entity in a base station 120 using the PDCP.

The shared lower layers include a physical (PHY) layer 306, a Medium Access Control (or Media Access Control) (MAC) layer 308, a Radio Link Control (RLC) layer 310, and a PDCP layer 312. The PHY layer 306 provides hardware specifications for devices that communicate with each other. As such, the PHY layer 306 establishes how devices connect to each other, assists in managing how communication resources are shared among devices, and the like.

The MAC layer 308 specifies how data is transferred between devices. Generally, the MAC layer 308 provides a way in which data packets being transmitted are encoded and decoded into bits as part of a transmission protocol.

The RLC layer 310 provides data transfer services to higher layers in the network stack 300. Generally, the RLC layer 310 provides error correction, packet segmentation and reassembly, and management of data transfers in various modes, such as acknowledged, unacknowledged, or transparent modes.

The PDCP layer 312 provides data transfer services to higher layers in the network stack 300. Generally, the PDCP layer 312 provides transfer of user plane 302 and control plane 304 data, header compression, ciphering, and integrity protection.

Above the PDCP layer 312, the stack splits into the user-plane 302 and the control-plane 304. Layers of the user plane 302 include an optional Service Data Adaptation Protocol (SDAP) layer 314, an Internet Protocol (IP) layer 316, a Transmission Control Protocol/User Datagram Protocol (TCP/UDP) layer 318, and an application layer 320, which transfers data using the wireless link 106. The optional SDAP layer 314 is present in 5G NR networks. The SDAP layer 314 maps a Quality of Service (QOS) flow for each data radio bearer and marks QoS flow identifiers in uplink and downlink data packets for each packet data session. The IP layer 316 specifies how the data from the application layer 320 is transferred to a destination node. The TCP/UDP layer 318 is used to verify that data packets intended to be transferred to the destination node reached the destination node, using either TCP or UDP for data transfers by the application layer 320. In some implementations, the user plane 302 may also include a data services layer (not shown) that provides data transport services to transport application data, such as IP packets including web browsing content, video content, image content, audio content, or social media content.

The control plane 304 includes a Radio Resource Control (RRC) layer 324 and a Non-Access Stratum (NAS) layer 326. The RRC layer 324 establishes and releases connections and radio bearers, broadcasts system information, or performs power control. The RRC layer 324 also controls a resource control state of the UE 110 and causes the UE 110 to perform operations according to the resource control state. Example resource control states include a connected state (e.g., an RRC connected state) or a disconnected state, such as an inactive state (e.g., an RRC inactive state) or an idle state (e.g., an RRC idle state). In general, if the UE 110 is in the connected state, the connection with the base station 120 is active. In the inactive state, the connection with the base station 120 is suspended. If the UE 110 is in the idle state, the connection with the base station 120 is released. Generally, the RRC layer 324 supports 3GPP access but does not support non-3GPP access (e.g., WLAN communications).

The NAS layer 326 provides support for mobility management (e.g., using a Fifth-Generation Mobility Management (5GMM) layer 328) and packet data bearer contexts (e.g., using a Fifth-Generation Session Management (5GSM) layer 330) between the UE 110 and entities or functions in the core network, such as the Access and Mobility Management Function 152 (AMF 152) of the 5GC 150 or the like. The NAS layer 326 supports both 3GPP access and non-3GPP access.

In the UE 110, each layer in both the user plane 302 and the control plane 304 of the network stack 300 interacts with a corresponding peer layer or entity in the base station 120, a core network entity or function, and/or a remote service, to support user applications and control operation of the UE 110 in the RAN 140.

### User Equipment-Coordination Set

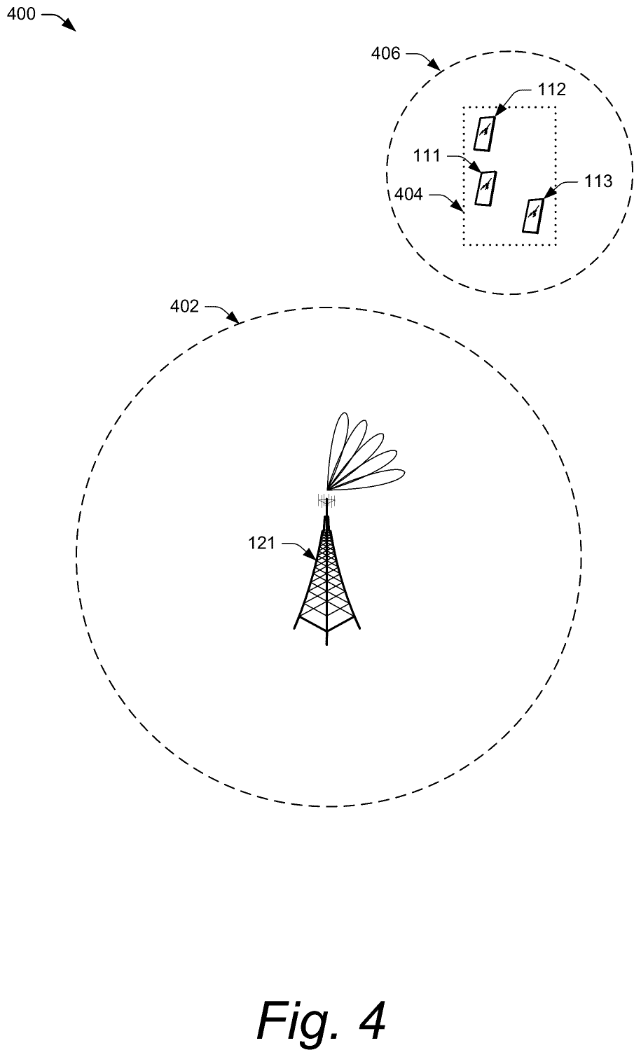

FIG. 4 illustrates an example environment in which various aspects of intra-user equipment-coordination set communication can be implemented. The illustrated example includes a base station 121, UE 111, UE 112, and UE 113. Although, for the sake of illustration clarity, the UECS in FIG. 4 is illustrated as including three UEs, any number of UEs greater than one may be included in a UECS. In an example, each of the UEs illustrated in FIG. 4 has limited transmit power which may result in difficulty transmitting uplink data to the base station 121. This may be due, at least partially, to the UEs being outside a communication range 402 of the cell provided by the base station 121 or the UEs being in a transmission-challenged location (e.g., a basement, urban canyon, etc.) such that each individual UE lacks a sufficient link budget to communicate with the base station 121.

Using the techniques described herein, a set of UEs (e.g., the UE 111, UE 112, and UE 113) can form a UECS (e.g., the UECS 404) using air interface resources allocated within the RAN 140 to synchronize and form a UECS. Based on a user input or predefined setting, each of the UEs may opt in or out of participation in the UECS. An effective transmit power of the target UE 112 can increase significantly (e.g., linearly) with the number of UEs in the UECS, which can greatly improve a link budget of the target UE 112.

In addition, UE coordination can be based on spatial beams or timing advance, or both, associated with each UE. For example, for beamforming or Massive-MIMO, it may be desirable that all the UEs within the UECS are able to receive the same signal from the base station. Therefore, the UECS may contain UEs positioned within a single antenna beam. Timing advance may indicate a distance between a UE and the base station. A similar timing advance for each UE in a group indicates that those UEs are approximately the same radial distance from the base station. Putting together both spatial and timing constraints, UEs within the same base station antenna beam that are all a similar distance from the base station, plus that are all within a threshold distance of a coordinating UE, may work together in a UECS in a distributed fashion to improve a signal strength and quality to the benefit of a target UE in the UECS.

Communication among the UEs can occur using a local wireless network 406, such as a PAN, NFC, Bluetooth, WiFi-Direct, local mmWave link, etc. In this example, all three of the UEs 111, 112, 113 receive potentially weak RF signals from the base station 121. The UE 111, UE 112, and UE 113 demodulate the RF signals to produce baseband I/Q analog signals and sample the baseband I/Q analog signals to produce I/Q samples. The UE 112 and the UE 113 forward the I/Q samples along with system timing information (e.g., system frame number (SFN)) using the local wireless network 406 to the coordinating UE 111 using their respective local wireless network transceivers 210. The coordinating UE 111 then uses the timing information to synchronize and combine the I/Q samples and processes the combined signal to decode data packets for the target UE 112. The coordinating UE 111 then transmits the data packets to the target UE 112 using the local wireless network 406.

When the target UE 112 has uplink data to send to the base station 121, the target UE transmits the uplink data to the coordinating UE 111 that uses the local wireless network 406 to distribute the uplink data, as I/Q samples, to each UE in the UECS 404. The base station 121 receives the jointly-transmitted uplink data from the UEs 111, 112, 113 and processes the combined signal to decode the uplink data from the target UE 112.

A set of UEs 110 may be able to monitor a base station 121 but individually each UE 110 is unable to reliably communicate with the base station 121. In this circumstance, the set of UEs 110 can form a UECS to communicate with the base station 121 without the base station 121 determining the configuration of the UECS and/or selecting a coordinating UE for the UECS. While various criteria (discussed below) may be used to determine the best candidate UE to become the coordinating UE, there may be instances where the UEs in the UECS share the role of the coordinating UE by scheduling multiple UEs to act as the coordinating UE based on a criteria such as time slots, power consumed performing coordinating UE operations, and/or an amount of data transferred while acting as the coordinating UE.

### Intra-User Equipment-Coordinating Set Communication

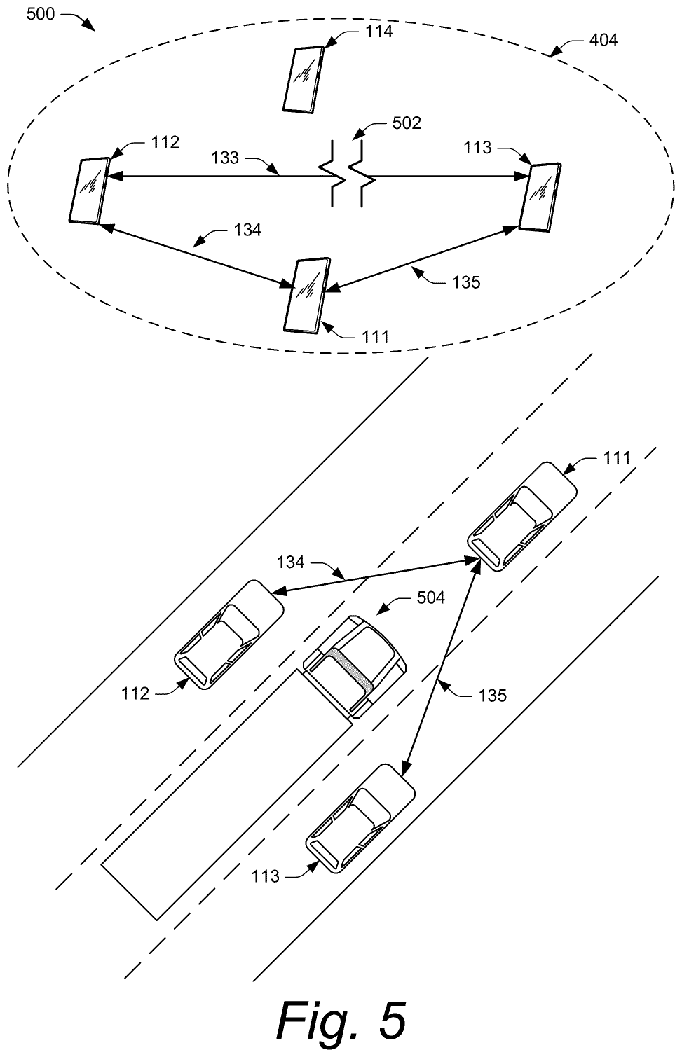

FIG. 5 illustrates an example environment 500, which includes the UECS 404 with multiple user equipment 110 (UE 110), illustrated as UE 111, UE 112, UE 113, and UE 114. The UEs 112 and 113 are attempting to conduct peer-to-peer communication (wireless connection 133) but encounter a blockage 502 that prevents successful peer-to-peer communication. For example, the UEs 111, 112, and 113 may be integrated into autonomous vehicles that are driving as a platoon and communicating at mmWave frequencies. Peer-to-peer communication may experience the blockage 502 as illustrated by a truck 504. In another example, hikers communicating with UEs in a UECS in hilly or mountainous terrain may experience impaired peer-to-peer communication based on blockage from terrain or path losses through foliage. To overcome these impairments to peer-to-peer communication, packet data communications within the UECS may be routed through an intermediate UE (e.g., the coordinating UE 111) to facilitate intra-UECS communication. If the UE 111 discontinues performing the role of the coordinating UE (e.g., due to low available resources such as battery charge level or the like), another UE in the UECS becomes the coordinating UE. For example, the UE 114 assumes the role of the coordinating UE, and the UE 114 begins routing packets for the intra-UECS communication between the UE 112 and the UE 113.

To support intra-UECS communication, the coordinating UE obtains an allocation of air interface resources for the intra-UECS communications from a base station. In one aspect, the coordinating UE 111 of the UECS 404 sends a request message to the base station to request the intra-UECS resource allocation. In response, the base station sends an RRC message including a resource grant for the intra-UECS communications. In another aspect, the base station may send a recurring grant for the intra-UECS communications when the UECS is formed by the base station. In further aspect, the base station may communicate the resource grant to the coordinating UE in a broadcast message. The resource grant in the broadcast message may be specific to a particular UECS or may be available to any UECS operating in the cell provided by the base station. The resource grant for the intra-UECS communication may include time, carrier frequency, spatial, and/or frequency band resource allocations. The resource grant may be for either Time Division Duplex (TDD) or Frequency Division Duplex (FDD) communication.

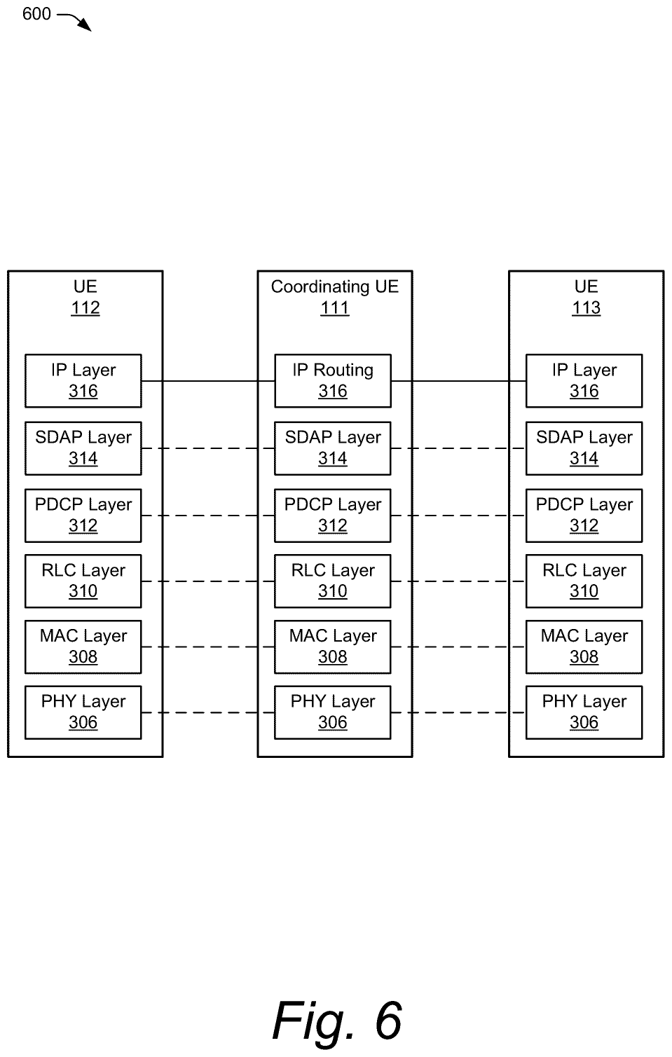

To overcome the blocking and link budget problems, described above, the coordinating UE 111 routes communications between UEs in the UECS. FIG. 6. illustrates an example block diagram 600 of IP routing using layers of the wireless network stack model 300 with which various aspects of intra-user equipment-coordination set communication can be implemented. Each UE in the UECS has an IP address for intra-UECS communication. The IP address for intra-UECS communication of each UE in the UECS may be provided by the base station. For example, the base station assigns IP addresses to each of the UEs in the UECS when forming the UECS and/or when the base station adds UEs to a UECS. In another example, the coordinating UE assigns IP addresses to each of the UEs in the UECS (including the coordinating UE itself) when forming the UECS and/or when the UEs are added to a UECS.

In a further example, the coordinating UE can assign an IP address to another UE in the UECS based on that other UE determining to initiate intra-UECS communication. A UE (e.g., the UE 112) initiates a Random Access Channel (RACH) procedure with the coordinating UE 111 including transmission of an RRC Connection Request message. During the RACH procedure, the coordinating UE 111 assigns an IP address to the UE 112 and includes the assigned IP address in the RRC Connection Setup message (Msg4) of the RACH procedure.

A UE in the UECS can discover the addresses of other UEs in the UECS by sending a discovery message to the coordinating UE. The coordinating UE then broadcasts the discovery message to the UEs in the UECS. Based on receiving the discovery message, any of the other UEs can choose to communicate with the UE that initiated the discovery message using the IP address included in the discovery message.

The coordinating UE 111 acts a router for intra-UECS communications by routing packets between UEs in the UECS. The coordinating UE maintains a store of routing information for UEs in the UECS. The routing information incudes layer 1 (L1), layer 2 (L2), and layer 3 (L3) context information for the non-coordinating UEs in the UECS. The routing information also includes mappings of the IP addresses of the UEs to UE context information, such as a MAC ID and/or Cell-Radio Network Temporary Identifier (C-RNTI) mapping.

The coordinating UE 111 can delegate the role of coordinating UE to another UE (e.g., UE 114) in the UECS. For example, the coordinating UE 111 may be in a low battery condition and delegates the role of coordinating UE 114 using RRC messaging. As part of the delegation, the coordinating UE 111 sends the intra-UECS routing information for the UECS to the new coordinating UE 114. If the UECS is within range of a base station or when the UECS regains connectivity to a base station, the new coordinating UE informs the base station of the change of coordinating UE for the UECS.

In aspects, the coordinating UE schedules air interface resources, previously granted by the base station to the UECS, to UEs for intra-UECS communication using dynamic resource grants. For example, the coordinating UE transmits a schedule of resources to the UEs in the UECS for intra-UECS communication. For example, the schedule includes an indication of air interface resources for each UE in the UECS to transmit packet data to the coordinating UE 111 and for each UE to listen for packet data from the coordinating UE. In aspects, the coordinating UE can also schedule semi-persistent or preconfigured resource grants for intra-UECS communications. In another aspect, the coordinating UE can schedule the non-coordinating UEs for discontinuous reception (DRX), and the coordinating UE can put UEs in the UECS in RRC-connected or RRC-inactive mode for intra-UECS communication.

In a further aspect, the coordinating UE can send unicast, multicast, and/or broadcast messages to non-coordinating UEs within UECS. For example, the coordinating UE can use multicast or broadcast messaging to coordinate satellite beam handovers (even when the UE cluster is stationary).

In another aspect, when the coordinating UE receives in intra-UECS data packet for a UE that is in the inactive mode, the coordinating UE can page the UE in the inactive mode. After receiving the page, the inactive-mode UE transitions to the connected mode to receive the intra-UECS data packet that is buffered at the coordinating UE.

### Data and Control Transactions

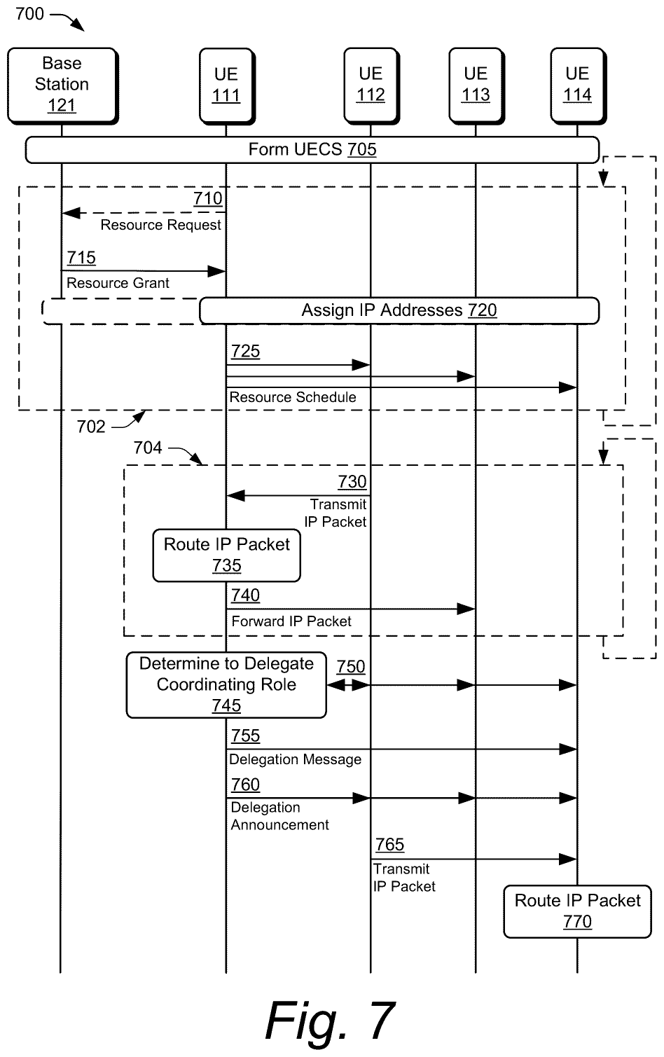

FIG. 7 illustrates data and control transactions between devices of a user equipment-coordination set in accordance with aspects of intra-user equipment-coordination set communication. Although not illustrated for the sake of illustration clarity, various acknowledgements for messages illustrated in FIG. 7 may be implemented to ensure reliable operations of intra-user equipment-coordination set communication.

At 705, a set of UEs (e.g., the UE 111, UE 112, UE 113, and UE 114) can form a UECS (e.g., the UECS 404). As a part of the formation of the UECS, the base station 121 selects the UE 111 as the coordinating UE for the UECS.

The base station provides a grant of air interface resources for intra-UECS communication. In one optional aspect at 710, the coordinating UE 111 sends a request message to the base station 121 to request the intra-UECS resource allocation. At 715, either in response to the request message or as a continuation of the formation of the UECS, the base station 121 transmits a resource grant to the coordinating UE 111 for intra-UECS communication. The resource grant may be one-time or recurring. In an alternative, the base station 121 can broadcast the resource grant (such as in a System Information Block (SIB)).

At 720, the coordinating UE 111 and/or the base station 121 assign IP addresses to the UEs in the UECS for intra-UECS communication. In one alternative, the base station 121 assigns addresses to each of the UEs. In another alternative, the base station 121 provides a block of IP addresses to the coordinating UE that the coordinating UE uses to assign individual IP addresses to each UE in the UECS. In another alternative, the coordinating UE assigns IP addresses based on configuration information provided by the RAN 140 or based on communications standards.

At 725, the coordinating UE 111 transmits a schedule of resources to the UEs in the UECS for intra-UECS communication. For example, the schedule includes an indication of air interface resources for each UE in the UECS to transmit packet data to the coordinating UE 111 and for each UE to listen for packet data from the coordinating UE. This schedule of resources allocates at least some of the resources indicated by the base station 121 in the earlier resource grant at 715. Optionally, the steps 710, 715, 720, and/or 725 (as shown in sub-diagram 702) may be repeated as needed to modify or update the resource grant, IP addresses, and/or the resource schedule, such as based on changes to the UEs included in the UECS or other factors.

At 730, the UE 112 transmits to the coordinating UE 111, in accordance with the received resource schedule, an IP data packet including a destination address of a destination UE. At 735, the coordinating UE 111 routes the received IP data packet by examining the destination address field of the IP data packet to determine the address of the destination UE. For example, if the destination address is the IP address of the coordinating UE 111, the IP layer 316 sends the contents of the data packet to the upper layers of the network stack 300. In another example, if the destination address is another UE in the UECS, such as the UE 113, the coordinating UE 111 forwards the IP data packet to the destination address at 740 in accordance with the resource schedule.

The coordinating UE 111 continues the process of receiving, routing, and forwarding packets until, at 745, the coordinating UE 111 determines to delegate the role of coordinating UE to another UE in the UECS. As a part of the determination at 745, the coordinating UE 111 polls other UEs in the UECS (at 750) to see which UEs are eligible to become the next coordinating UE (e.g., a UE with an appropriate user input or setting, a UE with higher battery level than the UE 111, or the like). For example, the coordinating UE 111 determines that the remaining charge capacity of its battery is low and, at 755, transmits a delegation message to the UE 114 to delegate the role of coordinating UE to the UE 114. The delegation message includes intra-UECS routing information and context information for the UEs in the UECS. At 760, the UE 111 sends a delegation announcement message to the UEs in the UECS that indicates that the UE 114 is the new coordinating UE for the UECS. The coordinating UE 111 can send the delegation announcement message in individual unicast messages to each UE or as a single multicast or broadcast message to all the UEs in the UECS.

At 765, after the delegation, intra-UECS communication continues via the new coordinating UE 114. The new coordinating UE 114 can request resources from the base station 121, assign or reassign IP addresses for Intra-UECS communication, and/or schedule resources for intra-UECS communication, as shown in sub-diagram 702. The new coordinating UE 114 can receive, route, and forward IP packets, as shown in the sub-diagram 704. For example, the UE 112 transmits an IP data packet including a destination address of the UE 113 to the coordinating UE 114. At 770, the coordinating UE 114 routes the received IP data packet by examining the destination address field of the IP data packet to determine the address of the destination UE.

### Example Method

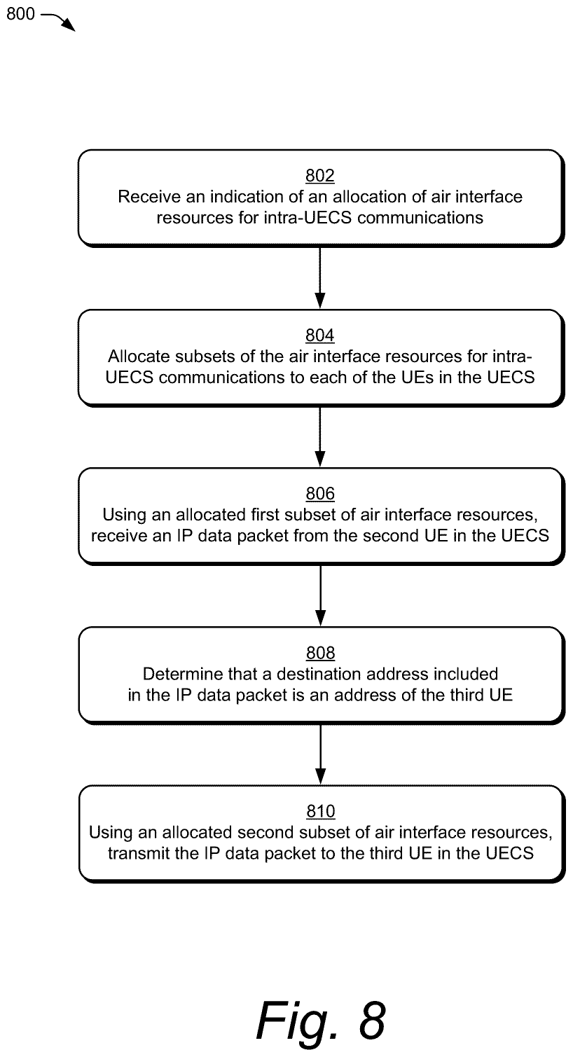

FIG. 8 illustrates example method(s) 800 of intra-user equipment-coordination set communication as generally related to routing intra-UECS packet data communications between UEs in the UECS. At 802, a coordinating user equipment (e.g., the UE 111) of a UECS receives an indication of an allocation of air interface resources for intra-UECS communication. For example, a base station (e.g., the base station 121) allocates air interface resources for intra-UECS communications. The coordinating UE receives the indication of this allocation in an RRC message (e.g., the resource grant 715). Optionally, the coordinating UE transmits a resource request message (e.g., the resource request 710) to the base station to direct the base station to allocate the air interface resources. Alternatively, the base station can broadcast the resource grant (such as in a System Information Block (SIB)).

At 804, the coordinating UE allocates subsets of the air interface resources for intra-UECS communications to each of the UEs in the UECS. For example, the coordinating UE allocates a first subset of air interface resources to a second UE (e.g., the UE 112) and a second subset of air interface resource to a third UE (e.g., the UE 113) for intra-UECS communication.

At 806, using the allocated first subset of air interface resources, the coordinating UE receives an IP data packet from the second UE in the UECS. For example, the coordinating UE receives an IP data packet including a source address, a destination address, and a payload from the second UE using the allocated first subset of air interface resources that are allocated for intra UECS communications from the second UE to the coordinating UE.

At 808, the coordinating UE determines that a destination address included in the IP data packet is an address of the third UE. For example, at the IP layer 316, the coordinating UE examines the address in the destination address field of the received IP data packet and determines that the destination address is the IP address of the third UE.

At 810, using the allocated second subset of air interface resources, the coordinating UE transmits the IP data packet to the third UE in the UECS. For example, based on determining the destination address is the IP address of the third UE, the coordinating UE transmits the IP data packet to the third UE using the allocated second subset of air interface resources that are allocated for intra UECS communications from the coordinating UE to the third UE.

Example method 800 is described with reference to FIG. 8 in accordance with one or more aspects of intra-user equipment-coordination set communication. The order in which the method blocks are described are not intended to be construed as a limitation, and any number of the described method blocks can be skipped, repeated, or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

In the following some examples are described:

Example 1: A method performed by a first user equipment, UE, configured as a coordinating user equipment for a user equipment-coordination set, UECS, in a wireless communications network, the method comprising the coordinating user equipment:
allocating first air interface resources to a second UE and second air interface resources to a third UE for intra-UECS communication;
receiving, using the allocated first air interface resources, an Internet Protocol, IP, data packet from the second UE in the UECS;
determining that a destination address included in the IP data packet is an address of the third UE; and
transmitting, using the allocated second air interface resources, the IP data packet to the third UE.

The method can provide a direct connection between UEs allowing communication between the UEs without requiring a base station or other external node to route communications between the UEs. The coordinating UE allocates air interface resources to other UEs in the UECS and can then map the air interface to respective IP addresses of the UEs in order to route communications between the UEs in the UECS. For example, the coordinating UE can transmit a schedule of resources to the UEs in the UECS for intra-UECS communication, wherein the schedule includes an indication of the air interface resources for each UE in the UECS to transmit packet data to the coordinating UE and for each UE to listen for packet data from the coordinating UE. The UEs in the UECS can then receive and transmit/forward IP data packets in accordance with the resource schedule. The air interface resource allocations may include time, carrier frequency, spatial, and/or frequency band resource allocations.

Example 2: The method of example 1, further comprising the coordinating user equipment:
receiving, from a base station, a resource grant of air interface resources for intra-UECS communication.

Example 3. The method of example 2, further comprising the coordinating user equipment:
receiving, from the base station, a reconfigured resource grant of air interface resources for intra-UECS communication.

Example 4. The method of example 2, wherein the received resource grant includes the first air interface resources and the second air interface resources.

Example 5. The method of example 4, wherein the first air interface resources and the second air interface resources are resources at the same frequency and different times.

Example 6. The method of example 4, wherein the first air interface resources and the second air interface resources are resources at the same frequency and different times.

Example 7: The method of example 2, wherein the receiving the resource grant of air interface resources for intra-UECS communication comprises the coordinating user equipment:
receiving the resource grant of air interface resources for intra-UECS communication when the UECS is formed.

Example 8: The method of example 2, wherein the receiving the resource grant of air interface resources for intra-UECS communication comprises the coordinating user equipment:
receiving the resource grant of air interface resources for intra-UECS communication in a broadcast message.

Example 9: The method of example 2, wherein the receiving the resource grant of air interface resources for intra-UECS communication comprises the coordinating user equipment:
transmitting a request message to the base station to request the resource grant of air interface resources for intra-UECS communication.

Example 10: The method of any one of the preceding examples, wherein each UE in the UECS has an IP address for intra-UECS communication provided by the base station. For example, wherein the base station assigns an IP address for intra-UECS communication to each UE in the UECS.

Example 11: The method of any one of the preceding examples, the method comprising the coordinating user equipment:
assigning an IP address for intra-UECS communication to each UE in the UECS.

Example 12: The method of any one of the preceding examples, the method comprising the coordinating user equipment:
receiving a Radio Resource Control, RRC, Connection Request message from a UE (e.g. the second or third UE, or a fourth UE);
in response to the receiving the RRC Connection Request message, assigning an IP address for intra-UECS communication to the UE;
including the IP address in an RRC Connection Setup message; and
transmitting the RRC Connection Setup message to the UE.

Example 13: The method of any one of the preceding examples, comprising the coordinating user equipment:
storing context information for intra-UECS communication of the second UE and the third UE; and
mapping the context information to the IP address of the respective UE.

Example 14: The method of example 13, comprising the coordinating user equipment:
determining to transfer the role of coordinating UE to a fourth UE;
transmitting a delegation message to fourth UE, the delegation message including intra-UECS context information; and sending one or more messages to the UEs in the UECS, the one or more messages indicating that the fourth UE is the coordinating UE for the UECS.

Example 15: The method of example 14, wherein the coordinating UE selects the fourth UE as a new coordinating UE based on the ability of the fourth UE to route IP data packets between the second UE and the third UE. For example, the new coordinating UE (the fourth UE) can receive, route, and forward IP packets, to and from the second and third UE. The first UE may also poll other UEs in the UECS to see which UEs are eligible to become the next coordinating UE (e.g., a UE with an appropriate user input or setting, and/or a UE with higher battery level than the first UE).

Example 16: The method of any one of the preceding examples, comprising the coordinating user equipment:
determining that the third UE is in an RRC inactive state; and
paging the third UE to direct the third UE to transition to an RRC Connected state to receive the IP data packet.

Example 17: The method of any one of the preceding examples, wherein the coordinating UE transmits the IP data packet to the third UE using:
unicast transmission;
multicast transmission; or broadcast transmission.

Example 18: The method of example 17, further comprising the coordinating user equipment: transmitting control information to UEs in the UECS using broadcast transmission.

Example 19: The method of any one of the preceding examples, wherein the allocating the first air interface resources to the second UE and the second air interface resources to the third UE for intra-UECS communication comprises the coordinating user equipment scheduling the air interface resources using:
a dynamic resource grant;
a semi-persistent resource grant; or
a preconfigured resource grant.

Example 20: The method of any one of the preceding examples, wherein the intra-UECS communication is Frequency Division Duplex, FDD, communication or Time Division Duplex, TDD, communication.

Example 21: A user equipment comprising:
a wireless transceiver;
a processor; and
instructions for a communication manager application that are executable by the processor to configure the user equipment to perform any one of the methods of examples 1 to 20. For example, the user equipment comprises computer-readable storage media comprising the instructions and the communication manager application.

Example 22: A computer-readable storage medium comprising instructions that, when executed by a processor, cause an apparatus comprising the processor to perform any of the methods of examples 1 to 20.

Although aspects of intra-user equipment-coordination set communication have been described in language specific to features and/or methods, the subject of the appended claims is not necessarily limited to the specific features or methods described. Rather, the specific features and methods are disclosed as example implementations of intra-user equipment-coordination set communication, and other equivalent features and methods are intended to be within the scope of the appended claims. Further, various different aspects are described, and it is to be appreciated that each described aspect can be implemented independently or in connection with one or more other described aspects.

1. A method performed by a first user equipment (UE) configured as a coordinating user equipment for a user equipment-coordination set (UECS) in a wireless communications network, the method comprising the coordinating user equipment:
allocating first air interface resources to a second UE and second air interface resources to a third UE for intra-UECS communication;
receiving, using the allocated first air interface resources, an Internet Protocol (IP) data packet from the second UE in the UECS;
determining that a destination address included in the IP data packet is an address of the third UE; and
transmitting, using the allocated second air interface resources, the IP data packet to the third UE.

2. The method of claim 1, further comprising the coordinating user equipment:
receiving, from a base station, a resource grant of air interface resources for intra-UECS communication.

3. The method of claim 2, further comprising the coordinating user equipment:
receiving, from the base station, a reconfigured resource grant of air interface resources for intra-UECS communication.

4. The method of claim 2, wherein the received resource grant includes the first air interface resources and the second air interface resources.

5. The method of claim 2, wherein the receiving the resource grant of air interface resources for intra-UECS communication comprises the coordinating user equipment:
receiving the resource grant of air interface resources for intra-UECS communication when the UECS is formed.

6. The method of claim 2, wherein the receiving the resource grant of air interface resources for intra-UECS communication comprises the coordinating user equipment:
receiving the resource grant of air interface resources for intra-UECS communication in a broadcast message.

7. The method of claim 2, wherein the receiving the resource grant of air interface resources for intra-UECS communication comprises the coordinating user equipment:
transmitting a request message to the base station to request the resource grant of air interface resources for intra-UECS communication.

8. The method of claim 2, wherein each UE in the UECS has an IP address for intra-UECS communication provided by the base station, the method comprising the coordinating user equipment:
assigning an IP address for intra-UECS communication to each UE in the UECS.

9. The method of claim 1, the method comprising the coordinating user equipment:
receiving a Radio Resource Control Connection Request message from a UE;
in response to the receiving the RRC Connection Request message, assigning an IP address for intra-UECS communication to the UE;
including the IP address in an RRC Connection Setup message; and
transmitting the RRC Connection Setup message to the UE.

10. The method of claim 1, comprising the coordinating user equipment:
storing context information for intra-UECS communication of the second UE and the third UE; and
mapping the context information to the IP address of the respective UE.

11. The method of claim 10, comprising the coordinating user equipment:
determining to transfer the role of coordinating UE to a fourth UE;
transmitting a delegation message to the fourth UE, the delegation message including intra-UECS context information; and
sending one or more messages to the UEs in the UECS, the one or more messages indicating that the fourth UE is the coordinating UE for the UECS,
wherein the coordinating UE selects the fourth UE as a new coordinating UE based on the ability of the fourth UE to route IP data packets between the second UE and the third UE.

12. The method of claim 1, comprising the coordinating user equipment:
determining that the third UE is in an RRC inactive state; and
paging the third UE to direct the third UE to transition to an RRC Connected state to receive the IP data packet.

13. The method of claim 1, wherein the coordinating UE transmits the IP data packet to the third UE using:
unicast transmission;
multicast transmission; or
broadcast transmission;
the method further comprising the coordinating user equipment:
transmitting control information to UEs in the UECS using broadcast transmission.

14. The method of claim 1, wherein the allocating the first air interface resources to the second UE and the second air interface resources to the third UE for intra-UECS communication comprises the coordinating user equipment scheduling the air interface resources using:
a dynamic resource grant;
a semi-persistent resource grant; or
a preconfigured resource grant.

15. The method of claim 1, wherein a user equipment-coordination set comprises multiple user equipments configured to jointly transmit and/or jointly receive data for one or more user equipments of the user equipment-coordination set, a user equipment-coordination set further comprising the coordinating user equipment configured to coordinate joint transmission and/or reception of downlink and/or uplink data.

16. A user equipment comprising:
a wireless transceiver;
a processor; and
instructions for a communication manager application that are executable by the processor to configure the user equipment (UE) to:
allocate first air interface resources to a second UE and second air interface resources to a third UE for intra user equipment-coordination set (intra-UECS) communication;
receive, using the allocated first air interface resources, an Internet Protocol (IP) data packet from the second UE in the UECS;
determine that a destination address included in the IP data packet is an address of the third UE; and
transmit, using the allocated second air interface resources, the IP data packet to the third UE.

17. The user equipment of claim 16, the instructions further executable to configure the UE to:
receive, from a base station, a resource grant of air interface resources for intra-UECS communication.

18. The user equipment of claim 16, wherein each UE in the UECS has an IP address for intra-UECS communication provided by a base station, the instructions further executable to configure the UE to:
assign an IP address for intra-UECS communication to each UE in the UECS.

19. The user equipment of claim 16, the instructions further executable to configure the UE to:
determine to transfer the role of coordinating UE to a fourth UE;
transmit a delegation message to the fourth UE, the delegation message including intra-UECS context information; and
send one or more messages to the UEs in the UECS, the one or more messages indicating that the fourth UE is the coordinating UE for the UECS,
wherein the coordinating UE selects the fourth UE as a new coordinating UE based on the ability of the fourth UE to route IP data packets between the second UE and the third UE.

20. The user equipment of claim 16, wherein the UE transmits the IP data packet to the third UE using:
unicast transmission;
multicast transmission; or
broadcast transmission;
the instructions executable to configure the UE to:
transmit control information to UEs in the UECS using broadcast transmission.
